(19) United States
(12) Patent Application Publication
(10) Pub. No.: US 2024/0340655 A1
(43) Pub. Date: Oct. 10, 2024

(54) TRANSMIT COVARIANCE MATRIX FEEDBACK FOR MIMO CHANNEL STATE INFORMATION

(71) Applicant: MEDIATEK INC., Hsinchu (TW)

(72) Inventors: TSUNG-WEI CHIANG, Hsinchu (TW); HSUAN-YI WU, Hsinchu (TW); Jiann-Ching Guey, Hsinchu (TW); Chien-Hwa Hwang, Hsinchu (TW)

(21) Appl. No.: 18/599,391

(22) Filed: Mar. 8, 2024

Related U.S. Application Data
(60) Provisional application No. 63/494,484, filed on Apr. 6, 2023.

(51) Int. Cl. H04W 16/28; H04B 7/06; H04L 5/00; H04W 24/08

(52) U.S. Cl. CPC H04W 16/28; H04B 7/0617; H04L 5/0051; H04W 24/08

(57) ABSTRACT

A user equipment (UE) measures one or more reference signals received from a base station to estimate a set of parameters that characterize a wireless channel between the UE and the base station. The set of parameters includes at least a respective departure angle associated with each path of a plurality of paths of the wireless channel. The UE transmits the set of parameters to the base station to enable the base station to facilitate beamforming strategies to enhance signal quality at the UE based on at least one of a channel matrix and a transmit covariance matrix associated with the wireless channel. The channel matrix and transmit covariance matrix are represented by the set of parameters.

This application claims the benefits of U.S. Provisional Application Ser. No. 63/494,484, entitled “TRANSMIT COVARIANCE MATRIX FEEDBACK FOR MIMO CHANNEL STATE INFORMATION” and filed on Apr. 6, 2023, which is expressly incorporated by reference herein in its entirety.

### BACKGROUND

### Field

The present disclosure relates generally to communication systems, and more particularly, to techniques of feeding back transmit covariance matrix.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The UE measures one or more reference signals received from a base station to estimate a set of parameters that characterize a wireless channel between the UE and the base station. The set of parameters includes at least a respective departure angle associated with each path of a plurality of paths of the wireless channel. The UE transmits the set of parameters to the base station to enable the base station to facilitate beamforming strategies to enhance signal quality at the UE based on at least one of a channel matrix and a transmit covariance matrix associated with the wireless channel. The channel matrix and transmit covariance matrix are represented by the set of parameters.

In an aspect of the disclosure, a method, a computer-readable medium, and an apparatus are provided. The apparatus may be a base station. The base station transmits one or more reference signals to a user equipment (UE). The base station receives a set of parameters from the UE. The set of parameters characterizes a wireless channel between the base station and the UE and includes at least a respective departure angle associated with each path of a plurality of paths of the wireless channel. The base station facilitates beamforming strategies to enhance signal quality at the UE based on at least one of a channel matrix and a transmit covariance matrix associated with the wireless channel. The channel matrix and transmit covariance matrix are represented by the received set of parameters.

To the accomplishment of the foregoing and related ends, the one or more aspects comprise the features hereinafter fully described and particularly pointed out in the claims. The following amdescription and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating multipath MIMO communication between a base station and one or more UEs.

FIG. 8 is a flow chart of a method for reporting channel state information to facilitate beamforming strategies at a base station.

FIG. 9 is a flow chart of a method for determining channel state information.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

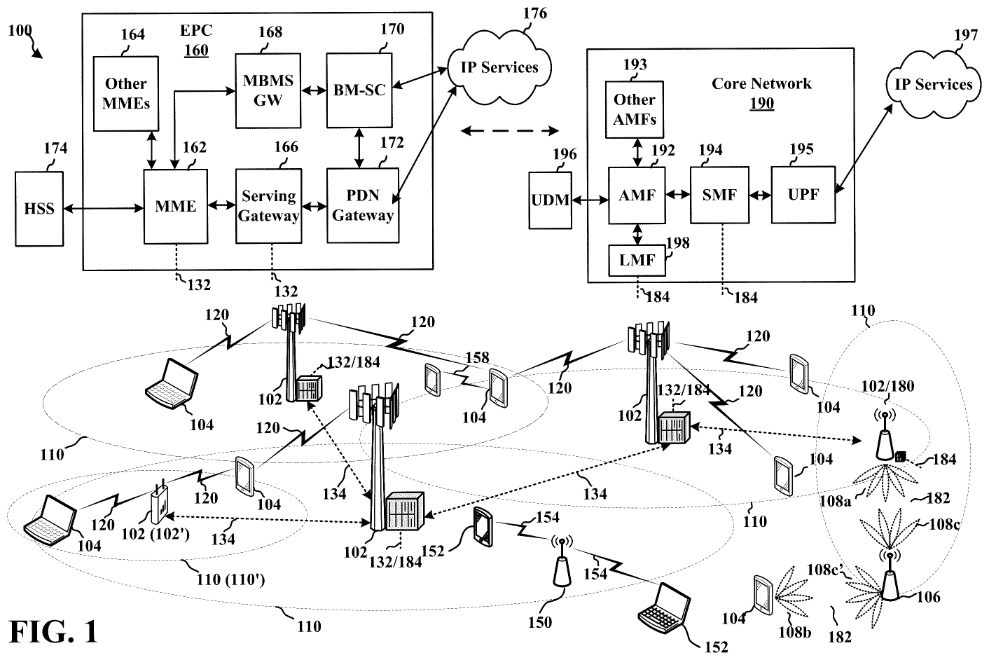

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR. The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available. The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

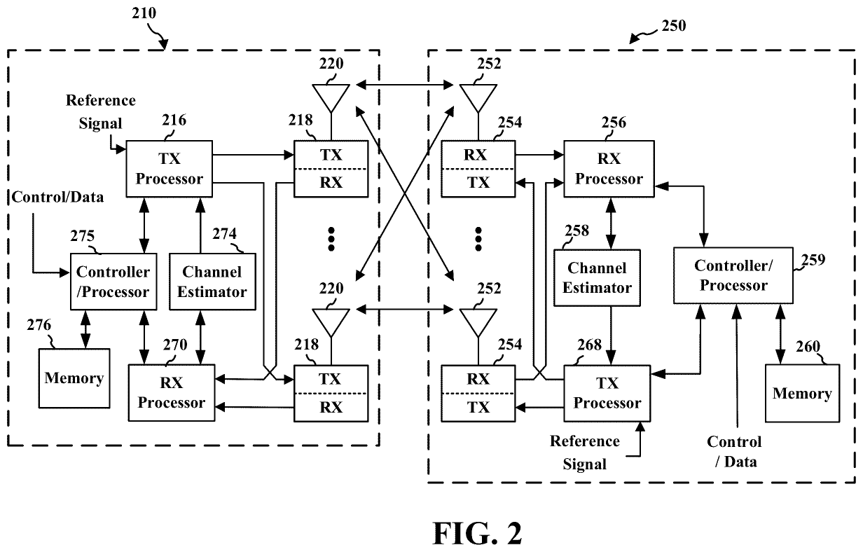

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

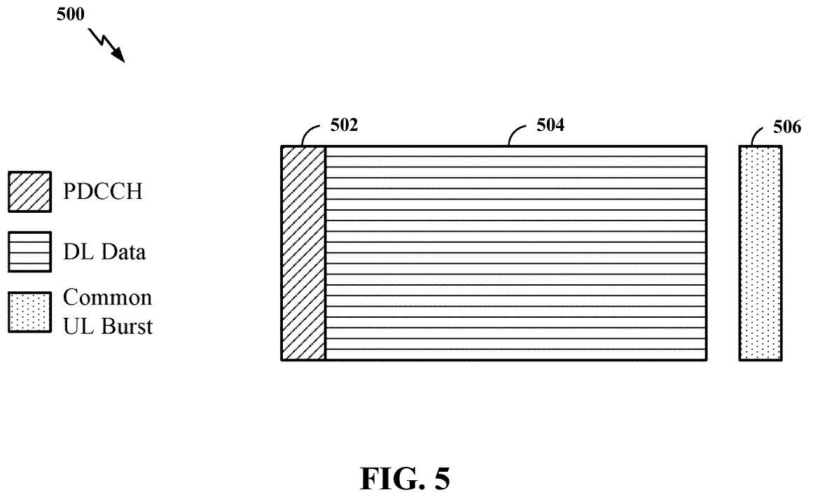

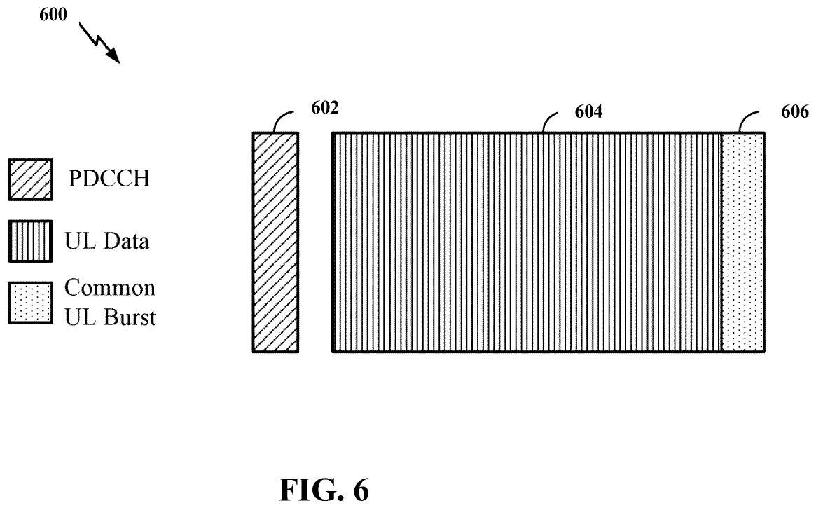

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUS). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

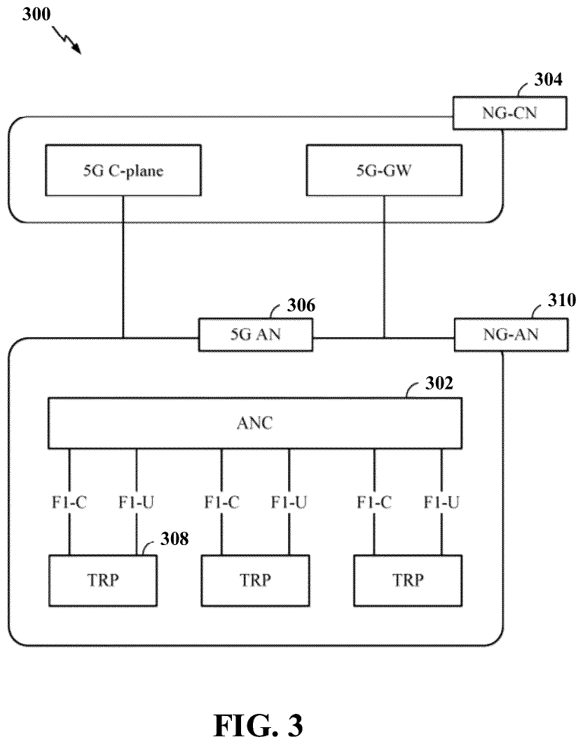

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

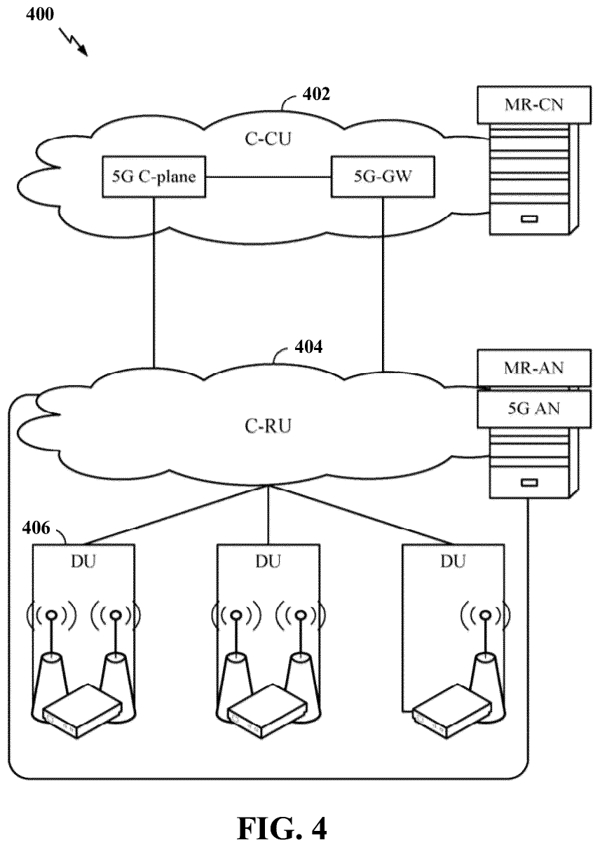

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

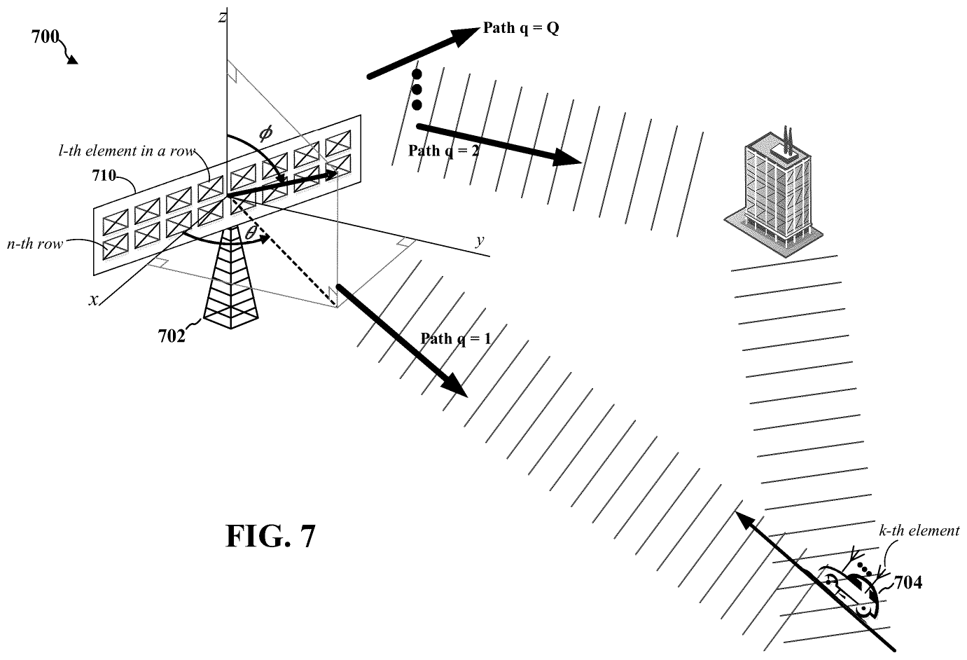

FIG. 7 is a diagram 700 illustrating multipath MIMO communication between a base station and one or more UEs. In this example, the base station 702 has an antenna array 710. In general, an antenna array 710 has n_{T}_{ₕ} elements (rows) in the elevation direction and n_{T}_{ᵥ} antenna elements in the azimuth direction. The antenna array 710 totally has n_{T}=n_{T}_{ᵥ}·n_{T}_{ₕ} antenna elements. Each antenna element has two polarizations. In this example, for the antenna array 710, n_{T}_{ₕ} is 2 and n_{T}_{ᵥ} is 8.

The base station 702 may use the antenna array 710 to transmit multiple beams simultaneously or sequentially. In this example, each beam, through Q different paths, reaches a UE 704. A beam, which reaches the UE 704 through a path q (q=1, . . . , Q), has a departure angle θ_{q} in the azimuth direction and a departure angle ϕ_{q} in the elevation direction. Further, the UE 704 totally has n_{R} antenna elements.

In this example, as shown, the beam transmitted by the base station 702 may be reflected by a building and arrive at the UE 704 through a path 2.

The wireless channel between the base station 702 and the UE 704 can be modeled as a MIMO channel with n_{R} receive antennas at the UE 704 and n_{T} transmit antennas at the base station 702. The channel coefficient between the l-th transmit antenna and the k-th receive antenna is denoted as hₖₗ[n, m], where n is the time index and m is the frequency index.

Accordingly, the MIMO channel coefficients may be represented by a matrix H[n, m]. The matrix is defined as:

$$H [ n , m ] = [ \begin{matrix}{h}_{11} [ n , m ] & … & {h}_{1 {n}_{T}} [ n , m ] \\ ⋮ & ⋱ & ⋮ \\ {h}_{{n}_{R} 1} [ n , m ] & … & {h}_{{n}_{R} {n}_{T}} [ n , m ]\end{matrix} ] .$$

This matrix contains the channel coefficients between the n_{R} antenna elements of the UE 704 and the n_{T} antenna elements of the base station 702's antenna array, across different times and frequencies.

In one aspect, different time indices are not considered and H[n, m] may be simplified as H[m]. Further, a transmit (TX) covariance matrix, denoted as ψ, may be derived from the MIMO channel matrix H[m], and is given by:

$$Ψ = \frac{1}{M} {\sum }_{m = 0}^{M - 1} {H}^{H} [ m ] H [ m ] ,$$

where M is the number of frequency samples.

This covariance matrix provides information about the state of the wireless channel. It reflects the variability of the channel coefficients, indicating how signal properties change over time and frequency.

Beamforming is used by the base station 702 to direct signal energy towards specific directions to enhance signal reception at one or more UEs. In particular, the base station 702, equipped with an antenna array having n_{T}_{ₕ} elements in the elevation direction and n_{T}_{ᵥ} elements in the azimuth direction, can generate multiple beams directed through different paths to the UE 704.

The covariance matrix ψ may assist in designing these beamforming strategies. By analyzing the statistical properties of the channel contained in ψ, the base station 702 can determine the optimal beamforming pattern to maximize signal quality at the UE. This involves calculating the directions (departure angles) and energy distribution among the beams to effectively use the MIMO channel's spatial characteristics.

The UE 704 measures reference signals transmitted by the base station 702 to estimate parameters that characterize the multipath MIMO channel. These reference signals, also known as pilot signals, are not intended for conveying actual data (such as a song or a video) but are specifically designed to enable the UE to estimate H[n, m]. For example, the reference signal may be CSI-RS.

In a first technique, the UE 704 may estimate a set of parameters based on the H[n, m]. The set of parameters include the departure angles in both azimuth (θ_{q}) and elevation (ϕ_{q}) directions for each path q. The set of parameters include a gain indication associated with each path q. For example, the gain indication represents the power or strength of the signal received from each path. In an embodiment, the gain indication may be derived by complex channel gain parameters (λ_{kq}) associated with each path q. The set of parameters include τ_{q} and v_{q}, which represent time delay and Doppler shift, respectively. The set of parameters may be collectively represented as ω_{q}=[θ_{q}, ϕ_{q}, τ_{q}, v_{q}]^{T}.

In some embodiments, the Q paths are the Q most significant paths according to the gain indication. In an embodiment, only one set of the departure angles corresponding to the path with strongest amplitude may be selected for reporting, such that there is no need to feedback the associated gain indication.

In some embodiments, the departure angles may be wideband departure angles. For example, the departure angles may be extracted based on an average version of channel covariance matrix Σₘ₌₁^{N3} H^{H}[m]H[m], where a subband m, 1≤m≤N3 is considered.

Once these parameters are estimated, instead of reporting the entire channel matrix H[m], in certain configurations, the UE 704 may report the set of parameters back to the base station 702. The base station 702 may reconstruct the MIMO channel matrix H[n, m] based on these parameters. Subsequently, the base station computes the transmit (TX) covariance matrix ψ, which is derived from the MIMO channel matrix as described supra.

The transmit (TX) covariance matrix, ψ, contains the state information of the wireless channel. Traditionally, the entire matrix or its direct coefficients would be reported from the UE 704 back to the base station 702. However, this approach can be bandwidth-intensive and inefficient, especially for systems with a large number of transmit antennas.

In a second technique, the UE 704 may compute the transmit (TX) covariance matrix ψ, which is derived from the MIMO channel matrix H[n, m]. In an embodiment, the UE 704 may compute the Singular Value Decomposition (SVD) of the TX covariance matrix:

ψ=VΣV^{H},

where Σ is a square diagonal matrix with dimension ρ much smaller than n_{T}, and V is a matrix of dimension n_{T}×ρ. This method significantly reduces the amount of information that needs to be fed back to the base station 702. Instead of reporting ψ directly, the quantized V and the diagonal elements of Σ (diag(Σ)) are fed back, or alternatively, the quantity of VΣ^{(1/2)} is reported.

Specifically, if ψ is a nᵣ×n_{T} matrix and there are ρ significant singular values, then Σ would be a ρ×ρ diagonal matrix. Hence, instead of reporting n_{T}² entries of ψ, the UE only needs to report n_{T}×ρ+ρ entries by feeding back V and Σ.

The UE 704 first estimates the channel matrix H[m] based on the reference signals. It then computes ψ and performs SVD to obtain V and Σ. Finally, it feeds back quantized versions of V and Σ to the base station 702. Upon receiving V and Σ, the base station 702 can reconstruct ψ=VΣV^{H}, which provides essential channel state information for tasks such as beamforming.

The basis vectors in V represent the directions in the signal space that are most significant for the communication channel, while the singular values in Σ quantify the strength of the channel in those directions. That is, that matrix ψ is projected onto a set of orthogonal bases, where only the bases (V) and the projection coefficients (Σ) need to be transmitted. The original matrix (ψ) can then be reconstructed at the receiver by multiplying the bases and coefficients. By projecting the channel onto these basis vectors, the UE 704 can capture the essential characteristics of the channel with fewer parameters. The projection coefficients, represented by diag(Σ), indicate how much of the signal is aligned with each of the basis vectors in V.

This compact representation of the channel state information allows the base station 702 to reconstruct an approximation of the original TX covariance matrix ψ and design optimal beamforming strategies to maximize signal quality at the UE 704. This approach not only simplifies the feedback mechanism but also aligns with the system's need to efficiently utilize bandwidth and computational resources. By reporting only the essential components of the TX covariance matrix in a compressed form, the system can achieve a balance between feedback accuracy and overhead.

### Case 1

In a first case of a second technique, for a uniform linear array, the antenna elements are arranged in a straight line with equal spacing. In this case, the antenna array 710 of the base station 702 only has a single row that is used for transmission.

The wireless channel between the base station 702 and the UE 704 can be modeled as a MIMO channel matrix H[m]. The channel coefficient between the l-th transmit antenna of the base station 702 and the k-th receive antenna of the UE 704 is denoted as hₖₗ[m], where m is the frequency index.

The channel coefficients for all transmit and receive antenna pairs can be represented in a matrix H[m] defined as:

$$H [ m ] = [ \begin{matrix}{h}_{11} [ m ] & … & {h}_{1 {n}_{T}} [ m ] \\ ⋮ & ⋱ & ⋮ \\ {h}_{{n}_{R} 1} [ m ] & … & {h}_{{n}_{R} {n}_{T}} [ m ]\end{matrix} ] ,$$

where n_{R} is the number of receive antennas at the UE 704 and n_{T} is the number of transmit antennas at the base station 702.

The uniform linear array only has azimuth angles θ_{q} associated with each departure path q. The row space of the MIMO channel matrix H[m] is spanned by sinusoidal steering vectors α_{q}. Each entry hₖₗ[m] can be expressed as a linear combination of complex exponentials:

$${h}_{kl} [ m ] = {\sum }_{q = 1}^{Q} {λ}_{kq} {e}^{j 2 π {τ}_{q} m + j 2 {πθ}_{q} l} ,$$

where q indexes the Q multipath components, λ_{kq} is the complex channel gain for multipath q, τ_{q} is the delay of multipath q, and θ_{q} is the departure angle of multipath q in the azimuth direction.

By substituting the above equation into H[m], the channel matrix can be expressed as:

$$H [ m ] = [ \begin{matrix}{h}_{1} [ m ] \\ ⋮ \\ {h}_{{n}_{R}} [ m ]\end{matrix} ] ,$$

The channel coefficients for the UE's k-th antenna element can be represented as:

$${h}_{k} [ m ] = [ {λ}_{k 1} [ m ] … {{λ}_{kQ} [ m ] [ {α}_{1} … {α}_{Q} ]}^{T} ,$$

where λ_{kq}[m] is the complex channel gain parameter for the q-th path at the m-th frequency index, and is defined as:

$${λ}_{kq} [ m ] = {λ}_{kq} {e}^{j 2 {πτ}_{q} m} ,$$

indicating that each path has a unique time delay τ_{q} and complex gain λ_{kq}, which affects the signal's phase and amplitude.

For a uniform linear array, the steering vector α_{q} is associated with the departure angle in the azimuth direction, denoted as θ_{q}, for each path q. It is defined as:

$${α}_{q} = [ {e}^{j 2 {πθ}_{q} \cdot 0} … {e}^{j 2 {πθ}_{q} \cdot ( {n}_{T} - 1 )} ] ,$$

where n_{T} is the total number of transmit antenna elements in the base station 702's antenna array. This vector captures the spatial signature of each path, determined by the departure angles.

As discussed, the UE 704 may feedback the key parameters such as ω_{q}=[τ_{q},θ_{q}] for q=1, . . . , Q. The vectors ω_{q}=[τ_{q},θ_{q}] for q=1, . . . , Q are represented in a two-dimensional Cartesian coordinate system with the τ-axis and the θ-axis. With knowledge of ω_{q}, the base station can reconstruct the steering vectors α_{q} and subsequently the channel matrix H[m]. This then allows computing the covariance matrix ψ.

The techniques described supra projects the MIMO channel matrix H[m] onto steering vectors. This technique is akin to the Singular Value Decomposition (SVD) concept, where a basis is identified, and the matrix is projected onto this basis to obtain the projection coefficients. However, the technique here employs a unique set of steering vectors. These vectors are linked to the physical configuration of the antenna array, such as the Uniform Linear Array (ULA) or the Uniform Planar Array (UPA).

For a ULA, where the antenna elements are arranged linearly with equal spacing, the steering vectors capture the spatial signature of the wireless channel based on the departure angles (θ_{q}) in the azimuth direction. Each path's channel coefficient hₖₗ[m] can be expressed as a linear combination of these steering vectors, weighted by the gain indication associated with each path q.

In this technique, the UE 704 may may feedback a set of key parameters that allow reconstructing H[m] and subsequently ψ at the base station 702. This is more efficient than transmitting the entire channel matrix.

The TX covariance matrix ψ is derived from the MIMO channel matrix H[m], which contains the channel coefficients between the base station 702's transmit antennas and the UE 704's receive antennas across different frequency indices. More specifically, the TX covariance matrix ψ is calculated as:

$$Ψ = \frac{1}{M} {\sum }_{m = 0}^{M - 1} {H}^{H} [ m ] H [ m ] = \frac{1}{M} {\sum }_{m = 0}^{M - 1} {\sum }_{k = 1}^{{n}_{R}} {h}_{k}^{H} [ m ] {h}_{k} [ m ] = {A}^{H} Λ A ,$$

$$where$$

$$Λ = \frac{1}{M} {\sum }_{m = 0}^{M - 1} {\sum }_{k = 1}^{{n}_{R}} {[ {λ}_{k 1}^{*} [ m ] … {λ}_{kQ}^{*} [ m ] ]}^{T} [ {λ}_{k 1} [ m ] … {λ}_{kQ} [ m ] ]$$

$$and$$

$$A = {[ {α}_{1} … {α}_{Q} ]}^{T} .$$

A is a matrix with the Q steering vectors. M is the number of frequency samples. H^{H}[m] denotes the Hermitian transpose of the MIMO channel matrix H[m] at the m-th frequency index. The matrix H[m] contains the channel coefficients hₖₗ[m] between the np receive antennas at the UE and the n_{T} transmit antennas at the base station's antenna array.

For a Uniform Linear Array, where the antenna elements are arranged in a straight line, the steering vectors A are defined based on the departure angles θ_{q} in the azimuth direction for each path q. The matrix A is composed of Q steering vectors stacked together, where each steering vector corresponds to a specific path from the base station 702 to the UE 704. The steering vectors capture the directional properties of the transmitted signals and are fundamental in beamforming applications.

As discussed, instead of feeding back the entire channel matrix H[m], the UE 704 may feedback key parameters ω_{q}=[τ_{q}, θ_{q}] that allow reconstructing H[m] at the base station 702. Specifically, the departure angles θ_{q} allow reconstructing the steering vectors α_{q}, while the channel gain parameters λ_{kq}[m] provide the coefficients for the linear combination. With α_{q} and λ_{kq}[m], the base station can reconstruct H[m] based on the above equations. Subsequently, the covariance matrix ψ can be computed.

Further, the covariance matrix ψ can be reconstructed in terms of the steering vectors A and a diagonal matrix Λ containing the complex channel gain parameters λ_{kq}, as shown below:

ψ=A^{H}ΛA,

where Λ is defined based on the complex channel gains λ_{kq} for each path q and each receiving antenna k at the UE 704. The diagonal elements of Λ represent the power or strength of the signal received from each path, and A^{H} denotes the Hermitian transpose of the steering vector matrix A.

The computation and feedback of the TX covariance matrix ψ and the associated parameters, such as the departure angles θ_{q} and the complex channel gains λ_{kq}, enable the base station to design optimal beamforming strategies. By analyzing the covariance matrix ψ, the base station can determine the best directions (departure angles) and energy distribution among the beams to effectively utilize the spatial characteristics of the MIMO channel, thereby enhancing the signal quality at the UE. As discussed, the matrix Λ contains information about the complex channel gain parameters λ_{kq} associated with each multipath component q and each receiving antenna k at the UE 704. Specifically, the diagonal elements of Λ represent the power or strength of the signals received from each multipath component.

This is evidenced by the equation:

$$Λ = \frac{1}{M} {\sum }_{m = 0}^{M - 1} {\sum }_{k = 1}^{{n}_{R}} {[ {λ}_{k 1}^{*} [ m ] … {λ}_{kQ}^{*} [ m ] ]}^{T} [ {λ}_{k 1} [ m ] … {λ}_{kQ} [ m ] ]$$

Here, λ*_{kq}[m] denotes the complex conjugate of λ_{kq}[m], which is the complex channel gain parameter for the q-th multipath component and the k-th receiving antenna at the m-th frequency index. By multiplying λ*_{kq}[m] with λ_{kq}[m], λ_{kq}[m]|² is obtained and gives the power or strength of the signal received through that multipath component.

Summing this over the M frequency indices and the n_{R} receiving antennas gives the total power received through each of the Q multipath components. This power information is contained in the diagonal matrix Λ.

In certain configurations, the UE 704 may feed back the power information (e.g., the diagonal elements of Λ). In certain configurations, the UE 704 may feed back the complex channel gain parameters λ_{kq} themselves. The base station can compute the power |λ_{kq}|² on its own. Furthermore, having the actual complex coefficients can enable more applications beyond just beamforming.

Therefore, the UE 704 may feed back one of: the power of the complex channel gains, represented by diag(Λ), the SVD of the Λ, and the actual complex channel gain parameters λ_{kq} themselves.

Further, the UE 704 may feed back the departure angles θ_{q} for q=1, . . . , Q.

With these parameters, the base station 702 can reconstruct the channel matrix H[m] or the transmit covariance matrix ψ to facilitate beamforming and other MIMO signal processing techniques. This provides an efficient feedback mechanism without reporting the entire channel matrix.

### Case 2

In a second case of the second technique, with uniform planar array (UPA), the antenna elements are arranged in a 2D grid configuration, adding an additional dimension. Thus, both azimuth and elevation angles are now associated with each departure path. That is, a UPA represents an antenna configuration where the antenna elements are arranged in a two-dimensional grid format. This arrangement allows for beamforming in both the azimuth and elevation directions.

In this example, the antenna array 710 at the base station 702 is characterized by n_{T}_{ₕ} elements in the elevation direction and n_{T}_{ᵥ} elements in the azimuth direction, totaling n_{T}=n_{T}_{ᵥ}·n_{T}_{ₕ} antenna elements. This configuration enhances the spatial diversity and beamforming capabilities of the base station 702, enabling it to transmit different beams through Q different paths to the UE 704, each with distinct departure angles θ_{q} and ϕ_{q} in the azimuth and elevation directions, respectively.

The MIMO channel between the base station 702 and the UE 704 is represented by a matrix H[m], encompassing the channel coefficients between the n_{R} receive antennas at the UE and the n_{T} transmit antennas at the base station's antenna array. Each entry of the H[m] may be represented as

$${h}_{kln} [ m ] = {\sum }_{q = 1}^{Q} {λ}_{kq} {e}^{j 2 {πτ}_{q} m + j 2 {πθ}_{q} l + j 2 {πϕ}_{q} n} .$$

In this 2D antenna layout, each transmit antenna element of the antenna array 710 can be indexed by two coordinates:
l=0, . . . , (n_{T}_{ᵥ}−1): the antenna index in the azimuth direction, and
n=0, . . . , (n_{R}−1): the antenna index in the elevation direction.

Similarly, each receive antenna element of the UE 704 can be indexed by:
k=0, . . . , (n_{R}−1): the antenna index at the receiver.

In this example, there are Q propagation paths or dominant propagation paths between the base station 702 and the UE 704, indexed by q=1, . . . , Q. Each path q is associated with:
λ_{kq}: complex channel gain,
τ_{q}: delay,
θ_{q}: departure angle in azimuth direction, and
ϕ_{q}: departure angle in elevation direction.

In the present disclosure, the terms complex channel gain and channel gain may be used interchangeably.

The channel coefficient hₖₗₙ[m] captures the wireless channel between:
transmit antenna with an index l in the azimuth direction and an index n in the elevation direction,
receive antenna with an index k, and
at frequency index m.

It can be expressed as a linear combination of the Q paths connecting the base station 702 and UE 704:

$${h}_{kln} [ m ] = {\sum }_{q = 1}^{Q} {λ}_{kq} {e}^{j 2 {πτ}_{q} m + j 2 {πθ}_{q} l + j 2 {πϕ}_{q} n} .$$

Each term (λ_{kq}e^{j2πτ}^{_{q}}^{m+j2πθ}^{_{q}}^{l+j2πϕ}^{_{q}}ⁿ) in the summation of hₖₗₙ[m] represents the contribution of one multipath component q, with its own delay τ_{q}, departure angles θ_{q}, ϕ_{q} in the azimuth and elevation directions respectively, and complex channel gain λ_{kq}.

More specifically, λ_{kq} represents the complex channel gain for the q-th path between the base station 702 and the k-th receiving antenna of the UE 704. It encapsulates the attenuation and phase shift experienced by the signal as it travels through path q.

e^{j2πτ}^{_{q}}^{m} models the time delay to experienced by the signal of path q at frequency index m, introducing a phase shift proportional to the frequency. e^{j2πθ}^{_{q}}^{l} captures the spatial signature of the signal in the azimuth direction, determined by the departure angle θ_{q} and the position l of the transmitting antenna element. e^{j2πϕ}^{_{q}}ⁿ captures the spatial signature of the signal in the elevation direction, determined by the departure angle ϕ_{q} and the position n of the transmitting antenna element in the elevation plane. The equation shows that the channel coefficient hₖₗₙ[m] is a function of: the transmit antenna indices l, n, the receive antenna index k, and the frequency index m. By aggregating the coefficients across all antenna pairs and frequency indices, the full MIMO channel matrix H[m] can be constructed.

In addition, the steering vectors α_{q} for the UPA are defined using the Kronecker product to encapsulate the combined effects of azimuth and elevation angles:

$${α}_{q} = [ {e}^{j 2 {πθ}_{q} \cdot 0} … {e}^{j 2 {πθ}_{q} \cdot ( {n}_{{T}_{v}} - 1 )} ] ⊗ [ {e}^{j 2 {πϕ}_{q} \cdot 0} … {e}^{j 2 {πϕ}_{q} \cdot ( {n}_{{T}_{h}} - 1 )} ] ,$$

where ⊗ denotes the Kronecker product. These vectors α_{q} encapsulate the spatial signature of the q-th path, defined by the departure angles θ_{q} in the azimuth direction and ϕ_{q} in the elevation direction.

Therefore, the channel matrix H[m] may be represented as:

$$H [ m ] = [ \begin{matrix}{h}_{1} [ m ] \\ ⋮ \\ {h}_{{n}_{R}} [ m ]\end{matrix} ] ,$$

$${h}_{k} [ m ] = {[ {λ}_{k 1} [ m ] … {λ}_{kQ} [ m ] ] [ {α}_{1} … {α}_{Q} ]}^{T} ,$$

$$where$$

$${λ}_{kq} [ m ] = {λ}_{kq} {e}^{j 2 {πτ}_{q} m} .$$

More specifically, H[m] denotes the channel matrix at the m-th frequency index, containing the channel coefficients between the n_{R} receive antennas at the UE 704 and the n_{T} transmit antennas at the base station 702's antenna array 710. Each row in H[m], represented by hₖ[m], corresponds to the channel coefficients from all transmit antennas to the k-th receive antenna at the UE 704.

The complex channel gain λ_{kq}[m] embodies the complex gain for the q-th path between the k-th receive antenna and the transmit antennas, modulated by the exponential term e^{j2πτ}^{_{q}}^{m}, which accounts for the time delay τ_{q} of the q-th path. This modulation captures the frequency-selective nature of the channel due to the multipath propagation.

For a UPA, the departure angles θ_{q} and ϕ_{q} are used in determining the direction of the beams formed by the base station 702 for data transmission towards the UE 704. The base station 702 utilizes these angles in conjunction with the complex gains λ_{kq}[m] to construct the beams used for data transmission that traverse through Q different paths, each characterized by a unique combination of azimuth and elevation departure angles.

By aggregating the coefficients across all antenna pairs and frequency indices, the full MIMO channel matrix H[m] can be constructed. More specifically, the UE 704 measures reference signals transmitted by the base station 702 to estimate parameters that characterize the multipath MIMO channel. These parameters include the departure angles θ_{q} and ϕ_{q}, the complex channel gain parameters λ_{kq}, and potentially the time delay τ_{q} and Doppler shift v_{q}, collectively represented as ω_{q}=[θ_{q}, ϕ_{q}, τ_{q}, v_{q}]^{T}.

Instead of reporting the entire channel matrix H[m], the UE 704 may feedback these key parameters to the base station 702. The base station then reconstructs the MIMO channel matrix H[n, m] based on these parameters, enabling the computation of the transmit (TX) covariance matrix ψ. This matrix is pivotal in designing beamforming strategies that maximize signal quality at the UE by optimally directing signal energy, for example, used for data transmission.

For a UPA, similar to a ULA, the transmit covariance matrix ψ is defined as:

$$Ψ = \frac{1}{M} {\sum }_{m = 0}^{M - 1} {H}^{H} [ m ] H [ m ] ,$$

Specifically, M is the number of frequency samples. H[m] is the n_{R}×n_{T} MIMO channel matrix between the n_{T} transmit antennas of the antenna array 710 at the base station 702 and the n_{R} receive antennas at the UE 704, at the m-th frequency index. H^{H}[m] represents the Hermitian transpose of H[m]. By averaging the outer product H^{H}[m]H[m] over M frequency samples, the TX covariance matrix ψ is obtained. The equation

$$Ψ = \frac{1}{M} {\sum }_{m = 0}^{M - 1} {\sum }_{k = 1}^{{n}_{R}} {h}_{k}^{H} [ m ] {h}_{k} [ m ]$$

represents the covariance matrix by writing H[m] in terms of its row vectors hₖ[m], which represent the channel coefficients from all transmit antennas to the k-th receive antenna as described supra. Here, k=1, . . . , n_{R} indexes the receive antennas of the UE 704, q=1, . . . , Q indexes the Q propagation paths between the base station 702 and UE 704. The channel coefficients hₖ[m] can be written in terms of the steering vectors α_{q} and channel gains λ_{kq}[m], which depend on key parameters that characterize the multipath channel.

Therefore, the TX covariance matrix ψ can be decomposed into:

$$Ψ = {A}^{H} Λ A ,$$

$$where$$

$$Λ = \frac{1}{M} {\sum }_{m = 0}^{M - 1} {\sum }_{k = 1}^{{n}_{R}} {[ {λ}_{k 1}^{*} [ m ] … {λ}_{kQ}^{*} [ m ] ]}^{T} [ {λ}_{k 1} [ m ] … {λ}_{kQ} [ m ] ]$$

$$and$$

$$A = {[ {α}_{1} … {α}_{Q} ]}^{T} .$$

A is a matrix with the Q steering vectors. M is the number of frequency samples. H^{H}[m] denotes the Hermitian transpose of the MIMO channel matrix H[m] at the m-th frequency index. The matrix H[m] contains the channel coefficients hₖₗ[m] between the n_{R} receive antennas at the UE and the n_{T} transmit antennas at the base station's antenna array.

Further, for the case of a uniform planar array (UPA), the feedback from the UE 704 may comprise the departure angles θ_{q} and ϕ_{q} for each path q=1, . . . , Q.

These angles, along with the number of antenna elements n_{T}_{ₕ} in the elevation direction and n_{T}_{ᵥ} in the azimuth direction of the antenna array 710, can be used by the base station 702 to reconstruct the matrix A containing the steering vectors α_{q}.

Specifically, the steering vectors for a UPA are defined as:

$${α}_{q} = [ {e}^{j 2 {πθ}_{q} \cdot 0} … {e}^{j 2 {πθ}_{q} \cdot ( {n}_{{T}_{v}} - 1 )} ] ⊗ [ {e}^{j 2 {πϕ}_{q} \cdot 0} … {e}^{j 2 {πϕ}_{q} \cdot ( {n}_{{T}_{h}} - 1 )} ] ,$$

where ⊗ denotes the Kronecker product between the azimuth component e^{j2πθ}^{_{q}}^{·l} and elevation component e^{j2πϕ}^{_{q}}^{·n}.

Given θ_{q}, ϕ_{q}, n_{T}_{ᵥ}, and n_{T}_{ₕ}, the base station 702 can reconstruct α_{q} and thus the matrix A.

Additionally, the UE 704 may feedback information regarding the matrix Λ. Similar to the case for ULA, different representations of Λ can be fed back, such as: the diagonal elements of Λ, containing just the power information, the singular value decomposition (SVD) of Λ, providing a more compressed representation, or the actual complex channel gain parameters λ_{kq} themselves.

With A and Λ, the base station 702 can reconstruct:

ψ=A^{H}ΛA,

which is the transmit covariance matrix derived from the channel matrix H[m].

The base station 702 can then utilize ψ to design optimal beamforming strategies that maximize signal quality at the UE 704. This feedback mechanism eliminates the need to report the full channel matrix while still providing sufficient information for beamforming.

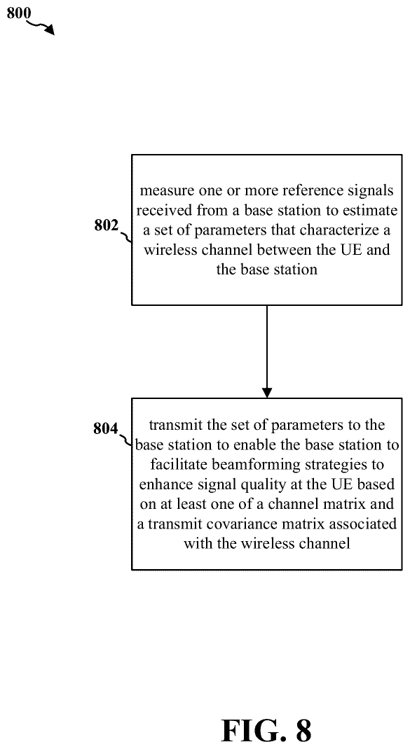

FIG. 8 is a flow chart 800 of a method for reporting channel state information to facilitate beamforming strategies at a base station. The method may be performed by an UE (e.g., the UE 704).

In operation 802, the UE measures one or more reference signals received from a base station, such as a base station 702, to estimate a set of parameters that characterize a wireless channel between the UE and the base station. The set of parameters includes at least a respective departure angle associated with each path of a plurality of paths of the wireless channel.

In certain configurations, the set of parameters further includes at least one of an azimuth departure angle and an elevation departure angle associated with each path of the plurality of paths of the wireless channel between the UE and the base station.

In certain configurations, the set of parameters further includes an indication of a channel gain, such as a complex channel gain parameter, associated with each path of the plurality of paths of the wireless channel between the UE and the base station.

In certain configurations, the set of parameters further includes a time delay associated with each path of the plurality of paths of the wireless channel between the UE and the base station.

In certain configurations, the set of parameters further includes a Doppler shift associated with each path of the plurality of paths of the wireless channel between the UE and the base station.

In operation 804, the UE transmits the set of parameters to the base station to enable the base station to facilitate beamforming strategies to enhance signal quality at the UE based on at least one of a channel matrix and a transmit covariance matrix associated with the wireless channel. The channel matrix and transmit covariance matrix are represented by the set of parameters.

In certain configurations, the UE computes a transmit covariance matrix associated with the wireless channel based on the channel matrix, decomposes the transmit covariance matrix via singular value decomposition (SVD) to obtain a matrix of basis vectors and a diagonal matrix of singular values, and transmits the matrix of basis vectors and the diagonal matrix of singular values to the base station.

In certain configurations, the set of parameters further includes powers of channel gains represented by diagonal elements of a matrix derived from channel gains associated with the plurality of paths between the UE and the base station.

In certain configurations, the set of parameters further includes a singular value decomposition (SVD) of a matrix derived from channel gains associated with the plurality of paths between the UE and the base station.

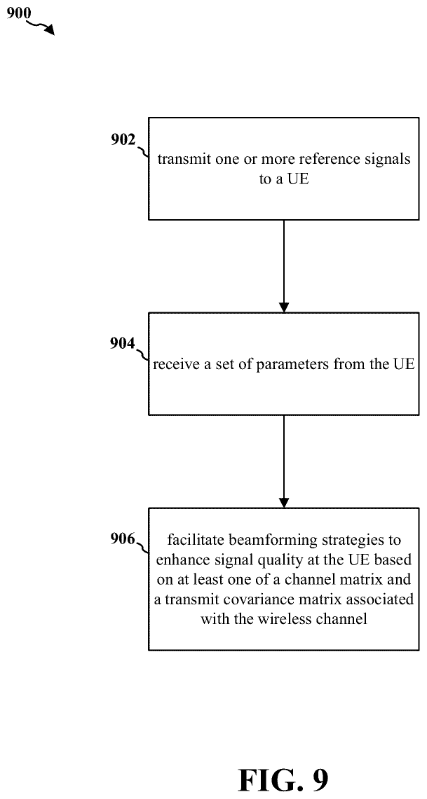

FIG. 9 is a flow chart 900 of a method for determining channel state information. The method may be performed by a base station (e.g., the base station 702). In operation 902, the base station transmits one or more reference signals to an UE. In operation 904, the base station receives a set of parameters from the UE. The set of parameters characterizes a wireless channel between the base station and the UE and includes at least a respective departure angle associated with each path of a plurality of paths of the wireless channel.

In certain configurations, the received set of parameters further includes at least one of an azimuth and an elevation departure angle associated with each path of the plurality of paths of the wireless channel between the base station and the UE.

In certain configurations, the received set of parameters further includes an indication of a channel gain associated with each path of the plurality of paths of the wireless channel between the base station and the UE.

In certain configurations, the received set of parameters further includes a time delay associated with each path of the plurality of paths of the wireless channel between the UE and the base station.

In certain configurations, the received set of parameters further includes a Doppler shift associated with each path of the plurality of paths of the wireless channel between the UE and the base station.

In operation 906, the base station facilitates beamforming strategies to enhance signal quality at the UE based on at least one of a channel matrix and a transmit covariance matrix associated with the wireless channel. The channel matrix and transmit covariance matrix are represented by the received set of parameters.

In certain configurations, the base station receives, from the UE, a matrix of basis vectors and a diagonal matrix of singular values obtained from a singular value decomposition (SVD) of a transmit covariance matrix associated with the wireless channel. The base station utilizes the matrix of basis vectors and the diagonal matrix of singular values to reconstruct the transmit covariance matrix.

In certain configurations, the received set of parameters further includes powers of channel gains represented by diagonal elements of a matrix derived from channel gains associated with the plurality of paths between the base station and the UE. The base station utilizes the powers of the channel gains to reconstruct the transmit covariance matrix.

In certain configurations, the received set of parameters further includes a singular value decomposition (SVD) of a matrix derived from channel gains associated with each path between the base station and the UE. The base station reconstructs the matrix derived from channel gain parameters based on the SVD of the matrix and utilizes the matrix to reconstruct the transmit covariance matrix.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication by a user equipment (UE), the method comprising:
measuring one or more reference signals received from a base station to estimate a set of parameters that characterize a wireless channel between the UE and the base station, wherein the set of parameters includes at least a respective departure angle associated with each path of a plurality of paths of the wireless channel; and
transmitting the set of parameters to the base station to enable the base station to facilitate beamforming strategies to enhance signal quality at the UE based on at least one of a channel matrix and a transmit covariance matrix associated with the wireless channel, wherein the channel matrix and transmit covariance matrix are represented by the set of parameters.

2. The method of claim 1, wherein the set of parameters further includes at least one of an azimuth departure angle and an elevation departure angle associated with each path of the plurality of paths of the wireless channel between the UE and the base station.

3. The method of claim 1, wherein the set of parameters further includes an indication of a channel gain associated with each path of the plurality of paths of the wireless channel between the UE and the base station.

4. The method of claim 1, wherein the set of parameters further includes a time delay associated with each path of the plurality of paths of the wireless channel between the UE and the base station.

5. The method of claim 1, wherein the set of parameters further includes a Doppler shift associated with each path of the plurality of paths of the wireless channel between the UE and the base station.

6. The method of claim 1, further comprising:
computing a transmit covariance matrix associated with the wireless channel based on the channel matrix;
decomposing the transmit covariance matrix via singular value decomposition (SVD) to obtain a matrix of basis vectors and a diagonal matrix of singular values; and
transmitting the matrix of basis vectors and the diagonal matrix of singular values to the base station.

7. The method of claim 1, wherein the set of parameters further includes powers of channel gains represented by diagonal elements of a matrix derived from channel gains associated with the plurality of paths between the UE and the base station.

8. The method of claim 1, wherein the set of parameters further includes a singular value decomposition (SVD) of a matrix derived from channel gains associated with the plurality of paths between the UE and the base station.

9. A method of wireless communication by a base station, the method comprising:
transmitting one or more reference signals to a user equipment (UE);
receiving a set of parameters from the UE, wherein the set of parameters characterizes a wireless channel between the base station and the UE and includes at least a respective departure angle associated with each path of a plurality of paths of the wireless channel; and
facilitating beamforming strategies to enhance signal quality at the UE based on at least one of a channel matrix and a transmit covariance matrix associated with the wireless channel, wherein the channel matrix and transmit covariance matrix are represented by the received set of parameters.

10. The method of claim 9, wherein the received set of parameters further includes at least one of an azimuth and an elevation departure angle associated with each path of the plurality of paths of the wireless channel between the base station and the UE.

11. The method of claim 9, wherein the received set of parameters further includes an indication of a channel gain associated with each path of the plurality of paths of the wireless channel between the base station and the UE.

12. The method of claim 9, wherein the received set of parameters further includes a time delay associated with each path of the plurality of paths of the wireless channel between the UE and the base station.

13. The method of claim 9, wherein the received set of parameters further includes a Doppler shift associated with each path of the plurality of paths of the wireless channel between the UE and the base station.

14. The method of claim 9, further comprising:
receiving, from the UE, a matrix of basis vectors and a diagonal matrix of singular values obtained from a singular value decomposition (SVD) of a transmit covariance matrix associated with the wireless channel,
wherein the reconstructing the transmit covariance matrix comprises utilizing the matrix of basis vectors and the diagonal matrix of singular values.

15. The method of claim 9, wherein the received set of parameters further includes powers of channel gains represented by diagonal elements of a matrix derived from channel gains associated with the plurality of paths between the base station and the UE, wherein the reconstructing the transmit covariance matrix comprises utilizing the powers of the channel gains.

16. The method of claim 9, wherein the received set of parameters further includes a singular value decomposition (SVD) of a matrix derived from channel gains associated with each path between the base station and the UE, wherein the reconstructing the transmit covariance matrix comprises:
reconstructing the matrix derived from channel gain parameters based on the SVD of the matrix; and
utilizing the matrix to reconstruct the transmit covariance matrix.

17. An apparatus for wireless communication, the apparatus being an UE, comprising:
a memory; and
at least one processor coupled to the memory and configured to:
measure one or more reference signals received from a base station to estimate a set of parameters that characterize a wireless channel between the UE and the base station, wherein the set of parameters includes at least a respective departure angle associated with each path of a plurality of paths of the wireless channel; and
transmit the set of parameters to the base station to enable the base station to facilitate beamforming strategies to enhance signal quality at the UE based on at least one of a channel matrix and a transmit covariance matrix associated with the wireless channel, wherein the channel matrix and transmit covariance matrix are represented by the set of parameters.

18. The apparatus of claim 17, wherein the set of parameters further includes at least one of an azimuth departure angle and an elevation departure angle associated with each path of the plurality of paths of the wireless channel between the UE and the base station.

19. The apparatus of claim 17, wherein the set of parameters further includes an indication of a channel gain associated with each path of the plurality of paths of the wireless channel between the UE and the base station.

20. The apparatus of claim 17, wherein the set of parameters further includes a time delay associated with each path of the plurality of paths of the wireless channel between the UE and the base station.
